(19) United States
(12) Patent Application Publication
(10) Pub. No.: US 2005/0086561 A1
(43) Pub. Date: Apr. 21, 2005

(54) Testing device

(76) Inventor: HC Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/820,767

(22) Filed: Apr. 9, 2004

(30) Foreign Application Priority Data
Oct. 17, 2003 (TW) 92128781

(51) Int. Cl. G06F 11/00

(52) U.S. Cl. 714/25

(57) ABSTRACT

A testing device for testing computer peripheral devices with Universal Serial Bus (USB) is provided. The testing device includes a CPU, a memory with a predetermined firmware program inside, which is connected to the CPU, a control chip with USB interface, which is connected to the CPU and is provided with a plurality of connecting ports for connecting with peripheral devices to be tested. The firmware program inside the memory is used for controlling the CPU to test the peripheral devices to be tested through the control chipset. According to one CPU and each peripheral device connected through by a control chip with USB interface for processing test procedures only, the hardware could be more simpler and efficiency.

### FIELD OF THE INVENTION

The present invention is related to a testing device, particularly to a testing device for testing peripheral devices provided with USB interface.

### BACKGROUND OF THE INVENTION

In current computer system, USB interface is used frequently and widely, mostly in the usage of computer peripheral devices. As a result, when peripheral devices with USB interface are produced in factories, they have to be tested before shipping.

Recently, the method of testing the peripheral devices with USB interface uses a personal computer installed with a USB control card for testing. FIG. 1 is a block diagram of conventional testing peripheral devices with USB interface. As shown in FIG. 1, a computer 10 is installed with a USB interface control card 12. Besides, peripheral devices 14 & 16 to be tested are connected to the USB interface control card 12. The peripheral devices 14 & 16 could be different kinds of peripheral devices with USB interface such as a mouse, a printer, a digital camera, a memory stick, etc.

After installing driver in computer 10, the peripheral devices 14 & 16 are tested by testing software to confirm whether they work or not. If the computer determines that it fails, the testing will not pass. By this way, the purpose of test is distinguishing whether the peripheral devices are ready for shipping or not.

However, the testing procedure requires at least one personal computer installed with related driver and testing program, which can not meet the need of low cost and high efficiency nowadays.

Therefore, for eliminating the deficiencies of the conventional testing peripheral devices with USB interface and the problems caused during the use of the testing device and for providing a solution by designing a structure which uses resource effectively to reduce the cost of equipment and to simplify the test procedure to increase test efficiency have been expected by users for a long time. The present invention is designed based on the inventor's experience in researching, developing and selling for years. Finally, the testing device of the present invention is designed after several times of designing, discussing, sampling and improvement to solve the above-mentioned problems.

### SUMMARY OF THE INVENTION

It is therefore a primary object of the present invention is to provide a testing device that uses only one CPU connected with peripheral devices to be tested through a USB control chip, which is used in testing the peripheral devices, to achieve the purposes of reducing the cost and simplifying the testing procedure.

According to the present invention, a testing device is provided including a CPU, a memory, and a control chip. The memory is provided with a predetermined firmware program inside and connected to the CPU. A control chip for controlling USB interface is connected to the CPU and provided with a plurality of connecting ports for connecting with peripheral devices to be tested. The firmware program inside the memory is used for controlling CPU to test the peripheral devices to be tested through the control chipset.

### BRIEF DESCRIPTION OF DRAWINGS

FIG. 1 is a block diagram of conventional testing peripheral devices with USB interface;

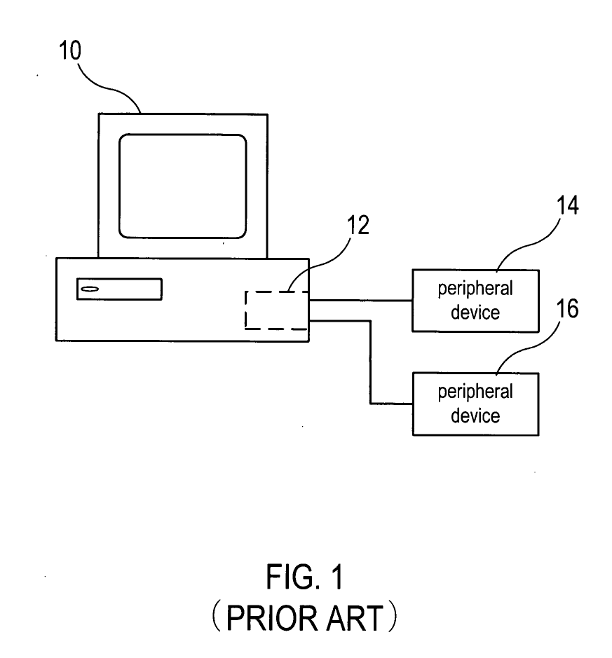

FIG. 2 is a block diagram of the testing device according to a preferred embodiment of the present invention; and

FIG. 3 is a flow chart of the testing device according to a preferred embodiment of the present invention.

### DETAILED DESCRIPTION OF THE EMBODIMENTS

The structural features and the effects to be achieved may further be understood and appreciated by reference to the presently preferred embodiments together with the detailed description.

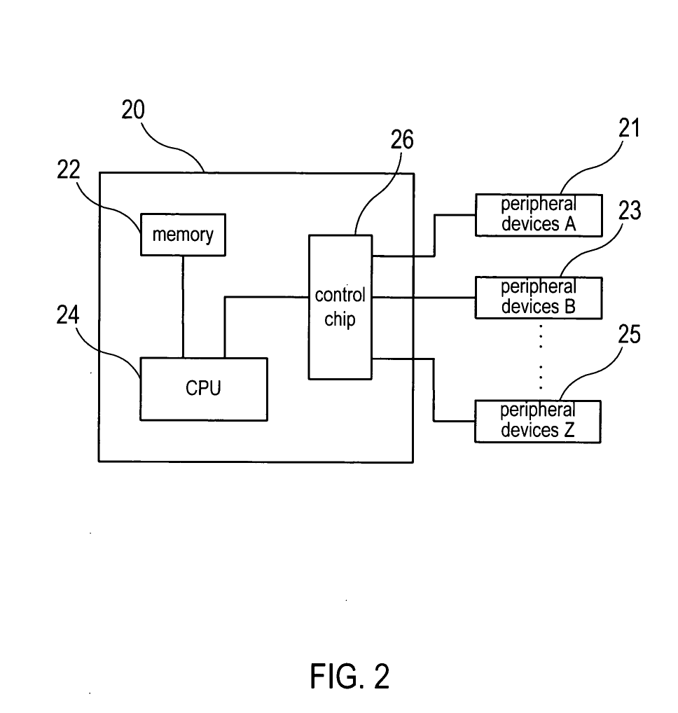

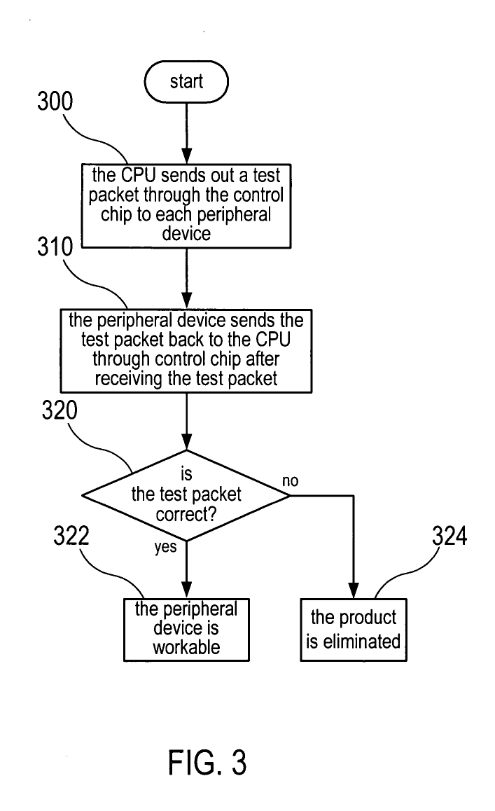

FIGS. 2 & FIG. 3 are respectively a block diagram of a testing device and a test flow chart of a preferred embodiment of the present invention. As shown in figures, a testing device 20 includes a CPU 24, a control chip 26, a memory 22 and a plurality of peripheral devices A 21, B 23 and Z 25 to be tested. The control chip 26 is used for controlling USB interface. The memory 22 is used for storing programs and data and connected to the CPU 24 to be accessed by the CPU 24. The peripheral devices A 21, B 23 and Z 25 to be tested are connected to the control chip 26. Each peripheral device is provided with USB interface so that the CPU 24 could test each peripheral device through the control chip 26.

The memory 22 has a predetermined test packet and a firmware program to provide the CPU 24 a testing procedure. As shown in step 300, according to the firmware program the CPU 24 sends out a test packet through the control chip 26 to each peripheral device, such as the peripheral devices A 21, B 23 and Z 25 shown in FIG. 2. After receiving the test packet, each peripheral device will send the test packet back to the CPU 24 through control chip 26, as shown in step 310. Finally, the CPU 24 will determine whether the test packet is the same as the predetermined test packet stored in the memory 22, as shown in step 320. If they are the same, it indicates the peripheral device is a workable product for shipping, as shown in step 322. Otherwise, the product is withdrawn from shipping as shown in step 324.

Thus, the simple circuit structure of the present invention is used for testing each peripheral device while reducing the cost effectively. A plurality of peripheral devices could be tested at one time, to fulfill the purposes of simplifying the procedure and increasing efficiency in the meantime.

As a conclusion, the present invention is related to a testing device that only uses one CPU to connect to the peripheral devices to be tested through a USB control chip, in order to achieve the purposes of reducing the cost and simplifying the testing procedure during test.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

### List of Reference Symbols

10. computer
12 USB interface control card
14 peripheral device
16 peripheral device
20 testing device
21 peripheral devices A
22 memory
23 peripheral devices B
24 CPU
25 peripheral devices z
26 control chip

1. A testing device for testing the peripheral devices with USB interface, comprising:
a CPU;
a memory with a predetermined firmware program, said memory connected with said CPU; and
a control chip with USB interface control, connected with said CPU, having a plurality of connecting ports for connecting with said peripheral devices,
wherein said firmware program of said memory is used for controlling said CPU to test said peripheral devices through said control chip.

2. The device of claim 1, wherein said memory is provided with a test packet.

3. The device of claim 2, wherein said CPU is able to send said test packet to said peripheral devices through said control chip.

4. The device of claim 3, wherein after receiving said test packet, said peripheral device sends back said test packet to said CPU for determining whether said test packet is the same as predetermined said test packet provided in the memory.

5. A testing device, implemented in at least one peripheral device, wherein said peripheral device is provided with a USB interface, said device comprising:
a CPU having a memory with a predetermined firmware program inside; and
a control chip with USB interface, connected to said CPU,
wherein said control chip is provided with a plurality of connecting ports for connecting with said peripheral devices.

6. The device of claim 5, wherein said memory is further provided with a test packet inside.

7. The device of claim 6, wherein said CPU is able to send said test packet to said peripheral device through said control chip.

8. The device of claim 7, wherein after receiving said test packet, said peripheral device sends said test packet back to said CPU for determining whether said test packet is the same as predetermined said test packet provided in the memory.

9. A testing device for testing at least one peripheral device, wherein said peripheral device is provided with USB interface, characterized by:
a CPU, connected with at least one memory, said memory comprising a firmware program for indicating said CPU; and
a control chip with USB interface control, connected to said CPU,
wherein said CPU is able to send a test packet stored in the memory to said peripheral device through said control chip;
wherein after receiving said predetermined test packet, said peripheral device sends said test packet back to said CPU for determining whether said test packet is the same as predetermined said test packet stored in the memory.
